(19) United States
(12) Patent Application Publication
(10) Pub. No.: US 2009/0115636 A1
(43) Pub. Date: May 7, 2009

(54) FUELAGE INFORMATION DISPLAY PANEL

(75) Inventor: Hideki Shibata, Shizuoka-ken (JP)

Correspondence Address: KNOBBE MARTENS OLSON & BEAR LLP, 2040 MAIN STREET, FOURTEENTH FLOOR, IRVINE, CA, 92614, US

(73) Assignee: Yamaha Hatsudoki Kabushiki Kaisha, Shizuoka-Ken (JP)

(21) Appl. No.: 11/910,604

(22) PCT Filed: Mar. 29, 2006
(86) PCT No.: PCT/JP2006/306456

§ 371 Date: Jun. 11, 2008

(30) Foreign Application Priority Data
Apr. 4, 2005 (JP) 2005-107302

(51) Int. Cl. G01C 21/00

(52) U.S. Cl. 340/971

(57) ABSTRACT

The present invention provides a fuselage information display panel of an aircraft for displaying a display section arranged vertically and horizontally provided for each of a plurality of different information items. The display section changes color according to the contents of the displayed information (e.g., whether the displayed information identifies normal or abnormal operation).

### CROSS-REFERENCE TO RELATED APPLICATIONS

This application is a U.S. National Phase of the International Application No. PCT/JP2006/306456 filed Mar. 29, 2006 designating the U.S. and published in Japanese on Oct. 12, 2006 as WO 2006/106730, which claims priority of Japanese Patent Application No. 2005-107302, filed Apr. 4, 2005.

### BACKGROUND OF THE INVENTION

1. Field of the Invention

The present invention relates to a fuselage information display panel for displaying a status of an instrument mounted on an aircraft, and more particularly to an airframe information display panel of an unmanned helicopter for applying agrochemicals or the like or for mounting a camera to take aerial photographs.

2. Description of the Related Art

Conventional radio-controlled unmanned helicopters can be used for applying agrochemicals from the sky or for taking aerial photographs or videos. As disclosed, for example, in Japanese Publication No. JP 2004-268737, a conventional unmanned helicopter of this type includes an unmanned helicopter of a so-called autonomous control type, which can fly out of the operator's sight by using the GPS (Global Positioning System). Such an unmanned helicopter with autonomous control can be used in a place such as, for example, a volcano and a disaster site, locations where it is difficult for a manned helicopter to reach.

Characteristically, the attitude of an unmanned helicopter is easily disturbed by wind. Further, structural features of such an unmanned helicopter result in extreme changes in attitude during a flight, for example, while a turn is made. The attitude of the unmanned helicopter is controlled mainly by servo motors of various types mounted on the airframe which change the tilt angle of the axis of the main rotor and the tilt angle of a blade of the main rotor and the tail rotor. If an unmanned helicopter of this type receives, for example, a strong crosswind, the current flight route may diverge significantly from an intended flight route. Autonomous control can also take a long time to correct a flight route.

A status of an aircraft or a flight route can be grasped and appropriately controlled from the ground by providing a communication means for transmitting and receiving data between the airframe or fuselage of the aircraft (e.g., a helicopter) and a ground station. The status of the airframe described above includes an operation status of a servo motor for controlling the attitude of the aircraft, an operation status of an engine, an operation status of various sensors for detecting the attitude angle of the airframe and the engine speed, the status of a battery in use mounted on the airframe, and so forth. On the other hand, the status of the flight includes the current status in relation to a flight route such as the direction, the altitude, and the location of a flying unmanned helicopter, and an operation status of a GPS device showing whether or not the GPS device is operating correctly. Data on the status of the airframe, the status of the flight, and so forth is transmitted from the airframe to the ground station and displayed on the monitor screen of a personal computer provided in the ground station.

When an unmanned helicopter is flying out of the operator's sight, the operator always needs to watch the data showing the status of the airframe and the flight to understand the status of the airframe and the flight.

Moreover, the operator needs to keep paying attention to instruments displaying a plurality of data to monitor the attitude control of the airframe and the flight route during a flight of the unmanned helicopter, and to monitor components mounted on the airframe to identify the occurrence of an undesired operating state of said components.

Such continuous monitoring can be taxing on the operator when he/she controls the helicopter for a long time. This is because it is extremely complex work to make an appropriate control by grasping the status of the airframe, the flight, and the payload described above by watching a number of data. In addition to this, it is difficult to make a quick decision without a skill in controlling and monitoring as described above.

### SUMMARY OF THE INVENTION

In view of the circumstances noted above, an aspect of the least one of the embodiments disclosed herein is to provide an airframe information display panel from which the operator can easily view the status of the instruments mounted on the airframe, information and a control status received from various sensors even at a single glance.

In accordance with one aspect of the invention, a fuselage information display panel of an aircraft is provided. The display panel comprises a plurality of display sections, the display sections configured to display different information items regarding the operation of the aircraft, wherein each display section changes color based at least in part on the contents of the displayed information.

In accordance with another aspect of the invention, a method for displaying information on a fuselage information display panel is provided. The method comprises displaying an information item regarding the operation of the aircraft in a display section having a first color when the contents of the displayed information identify a normal operating state, and changing the color of the display section to a second color different than the first color when the contents of the displayed information identify an undesirable operating state.

### BRIEF DESCRIPTION OF THE DRAWINGS

FIG. 1 shows a schematic side view of one embodiment of an unmanned helicopter.

FIG. 2 shows a schematic top view of the helicopter in FIG. 1.

FIG. 3 shows a schematic front view of the helicopter in FIG. 1.

FIG. 4 shows a block diagram of the unmanned helicopter according to one embodiment.

FIG. 5 shows a block diagram of a ground station, in accordance with one embodiment.

FIG. 6 shows a front view illustrating an example of display on a monitor at the ground station.

FIG. 7 shows a front view illustrating an example of display on the airframe information display panel, in accordance with one embodiment.

### DETAILED DESCRIPTION OF THE PREFERRED EMBODIMENTS

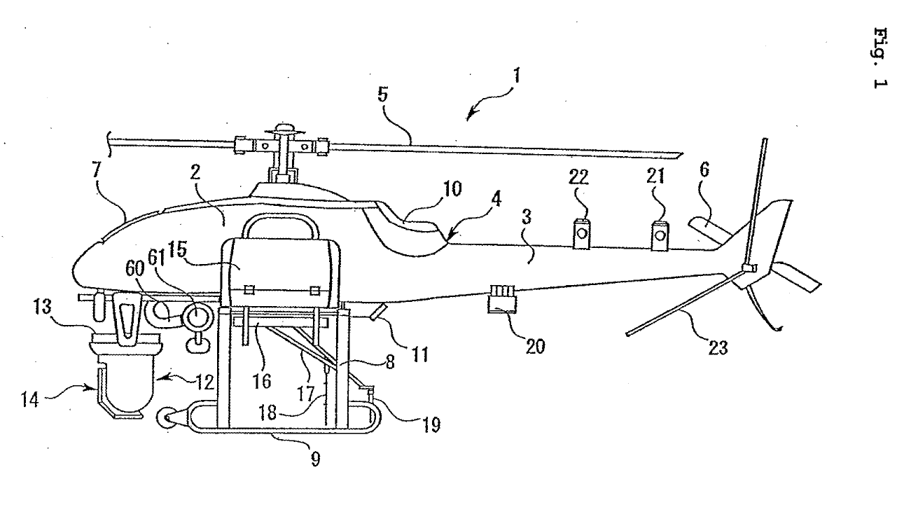

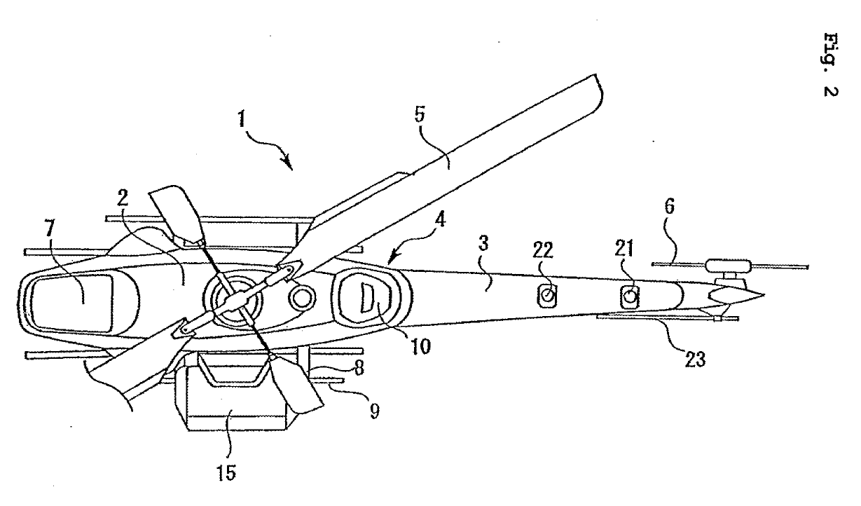

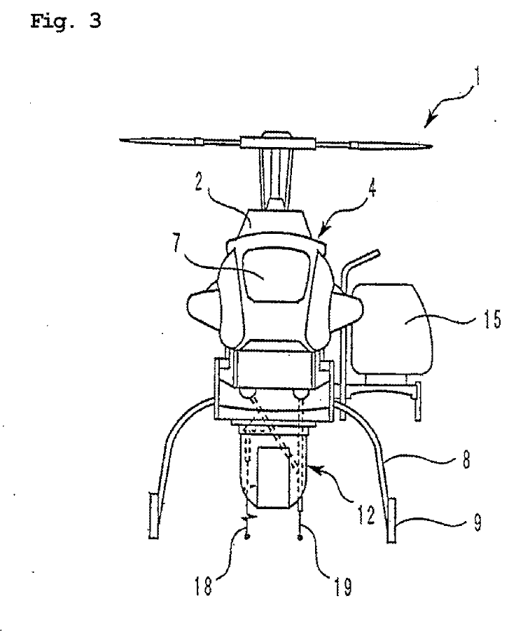

An embodiment of the airframe information display panel according to one embodiment will be described hereinafter in detail with reference to FIGS. 1 to 6. FIGS. 1 to 3 show one embodiment of a helicopter.

An unmanned helicopter 1 has an airframe 4 with a main body 2 and a tail body 3. A main rotor 5 is provided on the upper part of the main body 2, while a tail rotor 6 is provided on the rear part of the tail body 3. A radiator 7 is provided on the front part of the main body 2, and an engine, an intake system, a main rotor shaft, and a fuel tank are housed in this order behind the radiator 7 in the main body 2. The fuel tank with a large capacity is preferably housed in the vicinity of the center of the airframe in order to make an external sub-fuel tank unnecessary. Skids 9 can be provided via support legs 8 at the left and the right sides under the main body 2 and generally in the center of the airframe 4. An exhaust pipe 60 connected to the engine (not shown) in the airframe and a muffler 61 connected to the exhaust pipe 60 are disposed above the front end of the skids 9 under the airframe.

A control panel 10 is provided on the upper side of the rear part of the main body 2, while an indicating lamp 11 is provided on the lower side thereof. The control panel 10 can display checkpoints, a result of a self diagnosis, and the like before a flight. Display on the control panel 10 can be confirmed also at the ground station. The indicating lamp 11 can display the status of a GPS control, an undesirable operation (e.g., abnormality) warning of the airframe, and so forth.

A camera device 12 housing an infrared camera (or a CCD camera) can be mounted under the front part of the main body 2 via a camera mount 13. The camera device 12 can rotate around a pan shaft (a vertical shaft) on the camera mount 13. In addition, an internal camera (not shown) can rotate around a tilt shaft (a horizontal shaft). As a result, the camera can photograph pictures in all directions from the sky through a front window 14.

An autonomous control box 15 can be mounted on the left side of the main body 2. In the autonomous control box 15, a GPS control device for use in autonomous control, a data communication device and an image communication device for communication with the ground station, a control board with a control program built in, and so forth are housed. During the autonomous control, an operation mode and a control program prescribed in advance are selected automatically or according to a command from the ground station depending on various data described below. Thus, a navigation control optimal for the status of the airframe and a flight is performed. The various data described above include airframe data such as the attitude, the speed of the airframe, the engine speed and the throttle angle, and the like indicating the status of the airframe, flight data such as the location and the direction of the airframe indicating the status of the flight.

The helicopter 1 can be flown using such autonomous control. In addition, the helicopter 1 can also be flown manually fly by manual operation by the operator. The operator can manually operate the helicopter 1 visually monitoring the attitude, the speed, the altitude, the direction, and so forth of the helicopter 1, while operating a remote control device or a remote controller according to various data transmitted from the airframe.

An antenna support frame 16 is attached on the bottom surface of the main body 2. An inclined stay 17 is attached to the antenna support frame 16. A navigation data antenna 18 is attached to the stay 17 for transmitting and receiving navigation data (e.g., digital data) such as the airframe data and the flight data for the autonomous control described above to and from the ground station. Further, a picture data antenna 19 for transmitting image data recorded by the camera device 12 to the ground station by image communication (e.g., via an analog signal) is attached to the stay 17. Besides the analog type, a digital signal can also be used for the image communication.

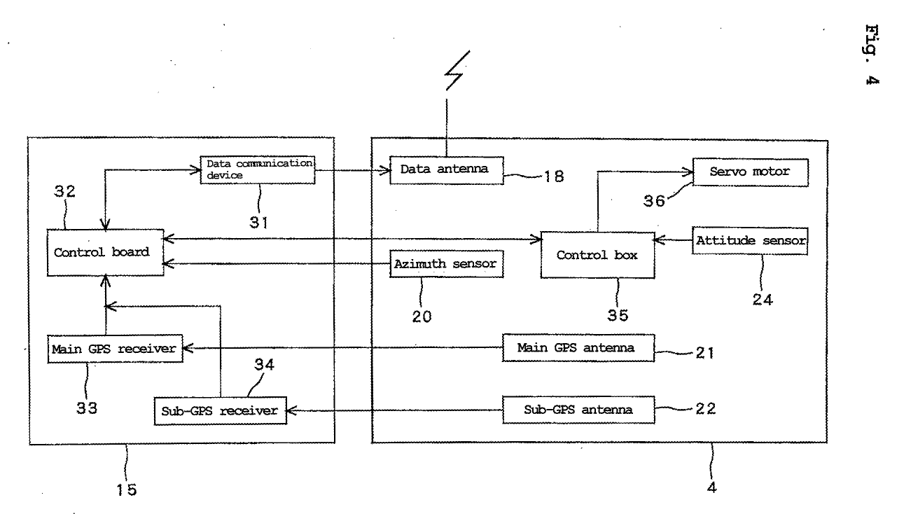

An azimuth sensor 20 based on ground magnetism and the like can be provided on the bottom side of the tail body 3. The azimuth sensor 20 detects a heading of the airframe (e.g., east, west, south and north). In addition, an attitude sensor 24, such as a gyro device (refer to FIG. 4) can be provided inside the main body 2.

A main GPS antenna 21 and a sub-GPS antenna 22 can be provided on the upper surface of the tail body 3. A remote control receiving antenna 23 for receiving a command signal from the remote controller is provided at the rear end of the tail body 3.

FIG. 4 shows a block diagram of the unmanned helicopter. The constitution concerning the control of the camera device is omitted from the drawing.

The autonomous control box 15 houses a data communication device 31 for transmitting and receiving data for the autonomous control of the unmanned helicopter 1 to and from the ground station, a control board 32 including a microcomputer storing an autonomous control program and so forth, a main GPS receiver 33 connected to the main GPS antenna 21, and a sub-GPS receiver 34 connected to the sub-GPS antenna 22.

The airframe 4 has the navigation data antenna 18 for transmitting and receiving digital data between the data communication device 31 in the autonomous control box 15 and the ground station. The azimuth sensor 20 is connected to the control board 32 in the autonomous control box 15. The attitude sensor 24 constituted with a gyro device and the like is provided inside the airframe 4. The attitude sensor 24 is connected to a control box 35. The control box 35 performs data communication with the control board 32 in the autonomous control box 15 and actuates a servo motor 36. There are five servo motors 36, which control the main rotor 5 and the engine to control the movement of the airframe 4 in the longitudinal direction, in the width direction, and in the vertical direction and also controls the tail rotor 6 in to control the rotation of the airframe 4.

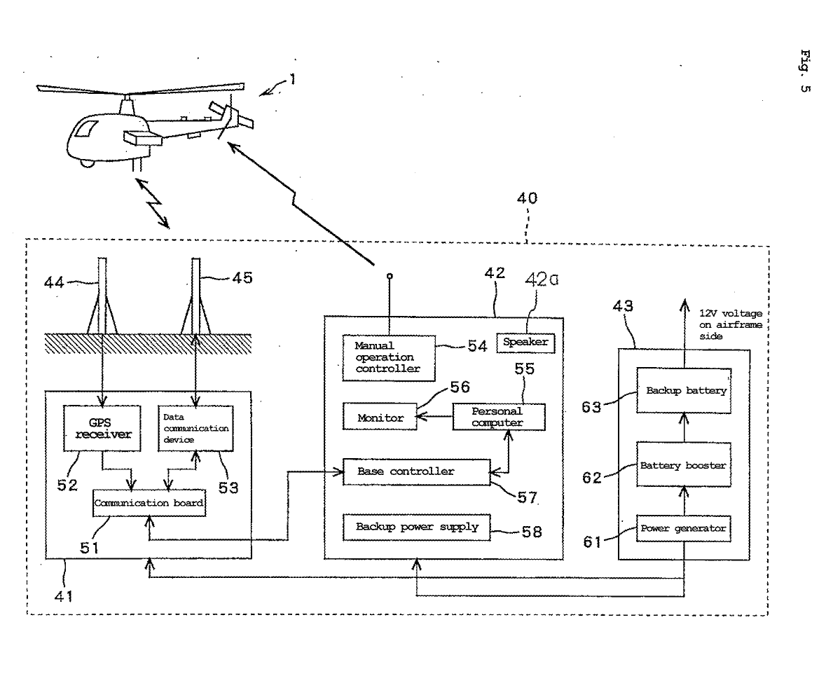

FIG. 5 shows a block diagram of the ground station.

A ground station 40 for communicating with the helicopter 1 is provided with a GPS antenna 44 for receiving a signal from a GPS satellite, a communication antenna 45 for performing data communication to and from the helicopter 1, and an image receiving antenna (not shown) for receiving image data from the helicopter 1. These antennas are provided on the ground.

The ground station 40 can include a data processing section 41, a monitoring operation section 42, and a power supply section 43.

The data processing section 41 includes a GPS receiver 52, a data communication device 53, and a communication board 51 connected to these components 52 and 53 for performing communication.

The monitoring operation section 42 includes a manual controller 54 operated by the remote controller, a base controller 57 for adjusting flight data of the airframe 4, a backup power supply 58, a personal computer 55 connected to the base controller 57, and a monitor 56 for the personal computer 55.

The power supply section 43 includes a power generator 61 and a backup battery 63 connected to the power generator 61 via a battery booster 62. The backup battery 63 is connected to the side of the airframe 4 to supply electric power of 12V when the power generator 61 is not operated, for example, while a check is made before a flight. Further, the power supply section 43 supplies electric power of 100V from the power generator 61 to the data processing section 41 and the monitoring operation section 42 while the helicopter 1 is flying.

In the illustrated embodiment, a command concerning the flight of the helicopter 1 is programmed by the personal computer 55 at the ground station 40 and transmitted from the ground station 40 to the helicopter 1 via the data processing section 41. When a data antenna 15 of the helicopter 1 receives the command, the attitude and the location of the airframe are controlled by the control board 32 (refer to FIG. 4). Thus, autonomous control of the helicopter 1 is performed.

Data on the status of the airframe 4, the status of the flight, and the like is transmitted from each sensor provided on the airframe 4 of the helicopter 1 to the ground station 40, and the data is displayed on the monitor 56 of the personal computer 55. The operator monitors the helicopter 1 by viewing the display on the monitor 56. The status of the flight or the like of the helicopter 1 can be corrected by remote control with the manual controller 54 and/or the personal computer 55.

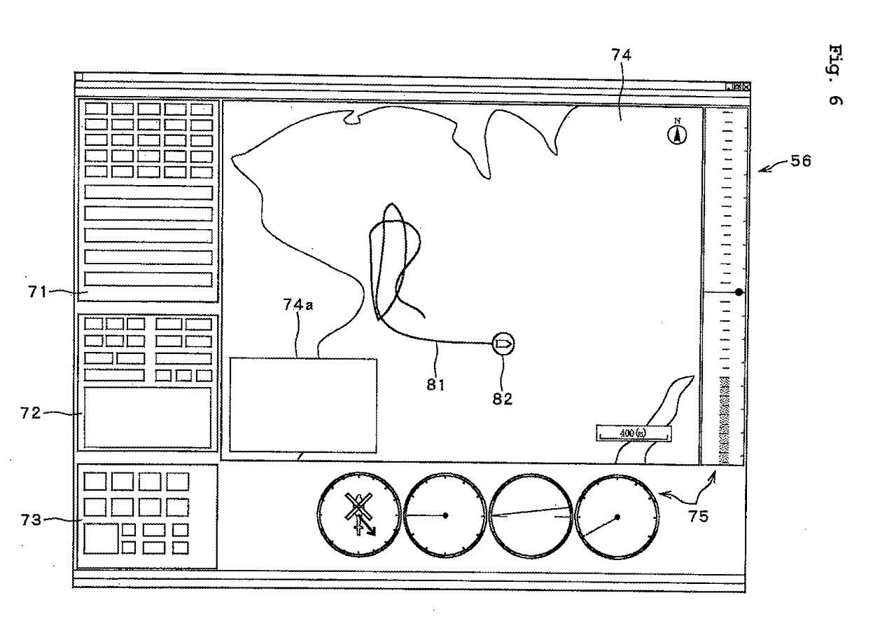

FIG. 6 shows an example of display on the monitor screen 56 of the personal computer 55 provided in the ground station 40. The arrangement of displayed information is not limited to the example in FIG. 6.

An airframe information display panel 71, a payload device information display panel 72, and a navigation panel 73 for the airframe 4 can be displayed in this order from the top left side on the monitor screen 56.

Data showing the status of the airframe and the status of the flight of the helicopter 1 and operating status of components, such as a servo motor 37 and various sensors are displayed on the airframe information display panel 71 with color, value, or character. Items displayed by value include detailed information on the GPS (e.g., latitude, longitude, altitude, and so forth), temperature of cooling water of the engine, battery voltage, and so forth. Items displayed via characters include the status of communication from the airframe 4 of the helicopter 1, a flight time, the status of the navigation by the GPS, whether or not a control is allowed, size of a control level, and so forth. Display by color is described in detail below.

When, for example, a camera device 12 having a pan function and a tilt function is mounted on the helicopter 1 for recording pictures, an operation panel for controlling the camera, for operating a pan angle and a tilt angle of the camera mount 13, and the like is displayed on the payload device information display panel 72. In such a case, information for confirming an operation mode relevant to this example is displayed as well as the display described above. When a payload is, for example, a delivery device for delivering agrochemicals from the sky other than the device described above, an operation panel and so forth for controlling the delivery device is displayed.

A navigation dialog box for inputting a target speed of the airframe, a relative movement dialog box for inputting a moved distance and an angle of the airframe, a parameter dialog box for changing a control parameter for the airframe, a program flight dialog box for transmitting and controlling a flight program, and so forth are displayed on the navigation panel 73. These dialog boxes may be displayed on the monitor screen 56 at the same time or may be displayed by switching the screen.

An instrument display section 75 including a plurality of instruments from which the current status of the airframe or the current status of the flight of the airframe 4 are known is displayed at the right side and in the lower section of the monitor screen 56. The instrument display section 75 displays the engine speed controlled by the control box 36, the horizontal speed and the vertical speed recognized by the GPS, the heading and the altitude recognized from the azimuth sensor and the attitude sensor, and a horizon indicator showing the attitude angle of the airframe, and so forth.

A map 74 of a region over which the helicopter 1 is flying can be displayed in the middle section on the monitor screen 56. The map 74 displays a topographical map, an azimuth, and a scale of the region of the flight. The trajectory of the flight route of the helicopter 1 is indicated by a line 81 on the topographical map. An airframe mark 82 indicating the current position and the heading direction of the airframe is shown at an end of the line 81. When the camera device is mounted on the helicopter, an image display section 74a for displaying images recorded by the camera may be provided on a part of the map screen. A still picture or a motion picture can be displayed as an image in the image display section 74a. In addition, the view point and the field of view of the camera can be displayed on the map 74.

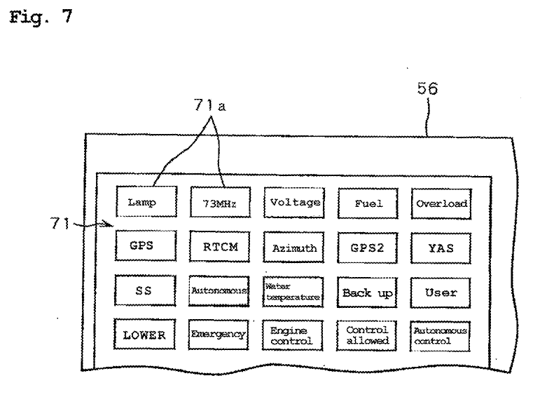

FIG. 7 shows one embodiment of a display on the airframe information display panel 71, illustrating a part of a display for identifying the contents of information with color in the entire display section of the airframe information display panel 71. As shown in FIG. 6 described above, the airframe information display panel 71 is displayed on a part of the monitor screen 56.

A display section 71a is arranged vertically and horizontally in accordance with each information and displayed on the airframe information display panel 71. Each display section 71a can independently show a color. Display is made according to a classification of colors achieved by emission color of illuminants constituting the monitor screen 56. For example, display is made in green in a case of complete normality, in yellow if an operation is normal but where some information is missing, in red if a problem has occurred or if a value is out of a predetermined range (e.g., identifying an undesirable operating state, such as an abnormal operating state), and so forth.

Further, when the color indicating normality is changed to another color, a warning sound can be generated from a speaker 42a (See FIG. 5) provided on the monitoring operation section 42. The speaker 42a constitutes a warning generation mechanism. In addition to this, display can be made in blue in case that the current operation is normal enough to achieve an operation in a higher level such as, for example, a case where it is possible to perform control in more severe operating conditions than the current condition.

Different colors are used on the display section 71a for displaying the lighting status of a lamp provided on the airframe 4, the operation status indicating whether or not a transmitter is normal, the voltage of a battery mounted on the airframe 4, the amount of remaining fuel (e.g., the amount of used fuel) loaded in the airframe 4, the output status of each sensor such as an altitude sensor, an azimuth sensor, and a GPS device provided on the airframe 4, the operation status indicating whether or not a servo motor provided on the airframe 4 is normal, the operation status of each control device for controlling the operation of the servo motor, and so forth.

For example, each display section 71a according to the embodiment is capable of displaying five colors which are green, blue, yellow, red, and purple. Of these colors, four colors, green, blue, yellow, and red are changed in accordance with a status of displayed information (for example, the status being normal or undesirable). Purple is the color commonly used for all of the display sections 71a to indicate a case in which data from the airframe 4 is not received. For example, green indicates normality or a normal use status similar to normality, red indicates an undesirable (e.g., abnormal) or a special use status, and blue and yellow indicate a status between normality and an undesirable state.

As the status between a case that the contents of displayed information are normal and a case that the contents of displayed information is undesirable, such as abnormal, is indicated by different colors in the constitution according to stages, it is possible to take a countermeasure such as making the airframe 4 land before the status becomes undesirable. According to types of displayed information, each display section 71a has an item the status of which is displayed in two colors of green and red, in addition to this, an item the status of which is displayed blue and yellow, and an item the status of which is displayed in blue or yellow.

In the example in FIG. 7, for example, the item “Lamp” can be displayed in two stages. Specifically, the item is displayed in green if the lamp on the airframe is off and displayed in red if the lamp on the airframe is on. As for the item “Control allowed,” green indicates a status in which the entire autonomous control is allowed, blue indicates a status in which backup by the sub-GPS device is not possible, yellow indicates a status in which the main GPS device is not usable but the sub-GPS device is usable for autonomous control, and red indicates a status in which autonomous control cannot be performed.

The item “Voltage” is lit in green if the battery voltage is in a predetermined range and lit in red if the battery voltage is out of the predetermined range. Further, the item “Autonomous” is in green if the autonomous switch on the remote controller is on and is in red if the autonomous switch is off. When the item “Autonomous” is displayed in red, remote control of the airframe is manually performed by the remote controller (e.g., the manual controller 54 in FIG. 5).

Consequently, according to the airframe information display panel 71 of the illustrated embodiment, the contents of information are displayed by a color in all of the display sections 71a. As a result, when all the display is in green, indicating normality, it is not necessary for the operator to make a judgment of normality or undesirability of each display section 71a by viewing an individual display section.

Further, in the display section 71a, the color in a case in which the contents of displayed information is normal and the color in a case in which the contents of displayed information is undesirable, e.g. identify abnormal operation, are different from each other. Therefore, it is easy to make a decision on the normal or undesirable operating state. As a result, an undesirable operating state is not overlooked by an operator even when operators are changed.

According to the airframe information display panel 71 of the embodiment, a warning sound is generated from the speaker 42a in addition to the fact that the color of the display section 71a is changed if equipment mounted on the airframe 4 for controlling the attitude such as the servo motor 36, equipment for the flight control such as the azimuth sensor 20 or equipment provided in the ground station 40 for controlling the airframe is not normal. In other words, when any of the display section 71a in a plurality of the display sections 71a is changed into a color other than green or when a warning sounded is heard, the operator can take a necessary action by viewing the airframe information display panel 71 and determining the status of the equipment. The range of a value and the status of each information indicated by colors on the display section 71a can be specified in advance by the user. Types of colors used for the display section 71a are not limited to the colors described above.

Further, in the airframe information display panel 71, the illuminants constituting the monitor screen 56 can be used for the items in which information is displayed with values and characters in order that the values, the characters, and the backgrounds thereof may be displayed in accordance with a classification of colors corresponding to the contends of information. In this case, the background is lit in red, for example, when a value is out of a predetermined range and when an error is caused, and, in addition to this, a warning sound is generated.

Still further, the airframe information display panel 71 of the embodiment is displayed on the monitor screen 56 displaying the status of the airframe 4 and the flight of the unmanned helicopter 1, which can perform an autonomous flight. As a result, according to the embodiment, the operator can grasp the status of an instrument mounted on the airframe 4 and the status of the flight of the airframe 4 promptly and appropriately even when the unmanned helicopter 1 is flying out of the operator's sight.

As discussed above, advantageously, the contents of each information is distinguished by a color corresponding to each item of information and displayed on the display section. The color is changed in accordance with the contents of information. Therefore, the operator does not need to pay attention closely to the entire display section on the display panel, but only needs to monitor whether or not, for example, the color indicates a normal status and to pay attention to the display section in which the color has changed. Consequently, the operator experiences less tiredness, even during an extended operation of the unmanned helicopter, and can pay attention to other information, such as the status of a flight, a payload device, and so forth.

As discussed above, when an undesirable operating state occurs, the display section is advantageously displayed in a color different from the color of a normal status. Therefore, it is easy to distinguish between a normal and an undesirable operation of a component, and the operator is less likely to overlook an undesirable operation of a component, even when operators are changed.

Moreover, since a status between normal and undesirable operation is displayed in a color corresponding to a stage, it is possible to take a countermeasure, such as making the aircraft land before the status becomes undesirable.

Additionally, when the operation of equipment mounted on the airframe for controlling the attitude, flight control equipment, or equipment provided in the ground station for controlling the airframe becomes undesirable, a warning sound can be advantageously generated in addition to the change in the color of the display section. Therefore, the operator is less likely to overlook an undesirable operation of a component and can recognize an undesirable status more readily.

The airframe information display panel can be displayed on the monitor screen for displaying the status of the airframe and the flight of the unmanned helicopter for performing an autonomous flight. Therefore, when the unmanned helicopter is flying out of the operator's sight, the operator can grasp the status of the instrument mounted on the airframe and the status of the flight promptly and appropriately.

The embodiments disclosed herein can be applied to an unmanned helicopter for applying agrochemicals or for taking aerial photographs, to a manned helicopter, and an airframe information display panel of an aircraft, such as an airplane other than the helicopters described above, a vehicle and so forth.

Although these inventions have been disclosed in the context of a certain preferred embodiments and examples, it will be understood by those skilled in the art that the present inventions extend beyond the specifically disclosed embodiments to other alternative embodiments and/or uses of the inventions and obvious modifications and equivalents thereof. In addition, while a number of variations of the inventions have been shown and described in detail, other modifications, which are within the scope of the inventions, will be readily apparent to those of skill in the art based upon this disclosure. It is also contemplated that various combinations or subcombinations of the specific features and aspects of the embodiments may be made and still fall within one or more of the inventions. Accordingly, it should be understood that various features and aspects of the disclosed embodiments can be combined with or substituted for one another in order to form varying modes of the disclosed inventions. Thus, it is intended that the scope of the present inventions herein disclosed should not be limited by the particular disclosed embodiments described above.

1-5. (canceled)

6. A fuselage information display panel of an aircraft comprising a plurality of display sections, the display sections configured to display different information items regarding the operation of the aircraft, wherein each display section changes color based at least in part on the operating state identified by the contents of the displayed information.

7. The fuselage information display panel of claim 6, wherein the plurality of display sections are arranged on the display panel in vertical columns and horizontal rows.

8. The fuselage information display panel of claim 6, where the color of the display section when the contents of the displayed information identify a normal state differs from the color of the display section when the contents of displayed information identify an undesirable state.

9. The fuselage information display panel of claim 6, wherein the color of the display section changes when the contents of the displayed information are between a normal state and an undesirable state.

10. The fuselage information display panel of claim 6, further comprising a warning generation mechanism configured to generate a warning signal, wherein the warning generation mechanism generates a warning signal when the color of the display section changes from a color corresponding to a normal state to a color corresponding to an undesirable state.

11. The fuselage information display panel of claim 10, wherein the warning signal is an audible signal.

12. The fuselage information display panel of claim 10, wherein the warning generation mechanism is a speaker configured to generate an audible warning signal.

13. The airframe information display panel of claim 6,
wherein the aircraft is an unmanned helicopter having an airframe that can communicate with a ground station, the airframe configured to be controlled from the ground station, the airframe configured to transmit data regarding a status of the airframe and a status of a flight to the ground station, the ground station configured to display the data transmitted from the airframe, the display section being displayed on at least one monitor screen of the ground station.

14. A method for displaying information on a fuselage information display panel, comprising:
displaying an information item regarding the operation of the aircraft in a display section having a first color when the contents of the displayed information identify a normal operating state; and
changing the color of the display section to a second color different than the first color when the contents of the displayed information identify an undesirable operating state.

15. The method of claim 14, further comprising:
changing the color of the display section to a color different than the first and second colors when the contents of the displayed information identify a state between the normal operating state and the undesirable operating state.

16. The method of claim 14, further comprising generating a warning signal when the color of the display section changes from the color corresponding to the normal operating state to the color corresponding to an undesirable operating state.

17. The method of claim 16, wherein generating a warning signal includes generating an audible signal.
